(19) United States
(12) Patent Application Publication
(10) Pub. No.: US 2005/0265257 A1
(43) Pub. Date: Dec. 1, 2005

(54) Networking apparatus and method

(76) Inventor: Yasuhiko Masuda, Kawasaki (JP)

Correspondence Address: Edward A. Pennington;Swidler Berlin Shereff Friedman, LLP, Suite 300, 3000 K Street, NW, Washington, DC, 20007-5116, US

(21) Appl. No.: 11/000,235

(22) Filed: Dec. 1, 2004

(30) Foreign Application Priority Data
May 27, 2004 (JP) 2004-157947

(51) Int. Cl. H04L 12/28

(52) U.S. Cl. 370/254

(57) ABSTRACT

A method and apparatus for configuring network apparatus is disclosed. Preferably, the method and apparatus eliminate the need for a user to manually set the operation mode of various apparatus. In one embodiment, the network apparatus may be connected to a network and is capable of selecting a network connecting operation mode. Moreover, the apparatus comprises a network connecting operation mode storing unit for storing a plurality of network connecting operation modes, a network communication unit for transmitting request information for requesting the network connecting operation mode to be set to the other network apparatus connected to the network and receiving the setting information from the other network apparatus, and a network connecting operation mode processing unit for setting the predetermined network connecting operation mode based on the setting information.

### CROSS-REFERENCE TO RELATED APPLICATIONS

This application is related to and claims the benefit of priority to Japanese Patent Application No. 2004-157947, filed May 27, 2004, in Japan, the contents of which are incorporated by reference herein.

### FIELD OF THE INVENTION

The present invention relates to a network apparatus and method which is capable of eliminating the need for a user to set the operating mode for network apparatus.

### BACKGROUND OF THE INVENTION

When a user desires to use the Internet, he or she is usually required to individually sign a contract with an Internet provider. The network connection modes employed are different for each Internet provider. Accordingly, a user is typically required to configure their personal computer and network apparatus such that it is capable of establishing an Internet connection through the provider. The configuration requirements may vary considerably between different providers.

In order to use a network apparatus, a user is required to set this network apparatus to communicate with the desired network environment. For example, when an ADSLK (Asymmetric Digital Subscriber Line) modem is used, a user sets this modem to the PPPoE (Point to Point Protocol over Ethernet) mode, and when an ADSL modem with a router function is used, a user sets this router to a required operation mode, such as the bridge mode. Japanese Patent Application Laid-Open No. 2000-155730 discloses a prior art method for connecting a network computer.

When a client and a server exist on the same network, the setting information is exchanged using the DHCP (Dynamic Host Configuration Protocol). If the client and server do not exist on the same network (acquisition of information by DHCP has failed), the operation mode of a client can be set automatically by reading the setting information from a local memory used by the client.

Accordingly, an operation mode which may be used from isolated distant networks connected through the Internet is automatically switched in accordance with the network environment or the like. As a result, a network computer which assures higher degree of flexibility during operation may be realized.

However, in the existing connecting method of network computers, it is not always guaranteed that the operation mode is switched to the desired mode in the environments where the DHCP server is not used. Moreover, since an end user such as the network computer is assumed to be a client, it is difficult for user to easily perform the setting of the apparatus, such as a router, without user's intervention.

Moreover, when a user sets up the operation mode of the network apparatus such as a router, it is essential for user to accurately detect the situations such as the network environment employed by the Internet provider and setting of the operation mode in accordance with the particular environment.

Such setting information and setting methods may be solved with the network apparatus manual and the support of the provider. However, a user needs a certain degree of network knowledge in order to read the manual or adequately communicate with the support provider. For ordinary users, it is considerably difficult to obtain this knowledge. In addition, dispatched support systems have been developed but these support systems often requires a certain support fee.

As described above, requiring a user to configure network apparatus to communicate over an Internet connection may become complicated and time consuming.

Even in the side of a network apparatus developing maker, problems of connection failure by erroneous setting of user are generated because of difficulty in the setting of the network apparatus. A continuing need exists for an apparatus and method that is capable of simplifying the configuration of network apparatus.

### SUMMARY OF THE INVENTION

In one embodiment, the present invention is capable of allowing a user who has only a rudimentary understanding of a network system to easily set up the network environment. This is preferably accomplished by setting the operation mode of the network apparatus without requiring substantial user intervention.

The client-side network apparatus of the present invention, which may be connected to a network in order to select a network connecting operation mode, preferably includes a network connecting operation mode storage unit for storing a plurality of network connecting operation modes. Also included is a network communication unit. This unit is capable of determining the network connecting operation mode by receiving the setting information from the other network. This embodiment also includes a network connecting operation mode processing unit that is capable of setting the network apparatus to the operating mode based on the received setting information.

The server-side network apparatus of the present invention, which can set up network connection, comprises a setting information storage unit capable of storing the setting information of the network connecting operation mode. Also included is a network communication unit for receiving the request information from the client-side network apparatus. This unit may then be capable of transmitting the setting information to the client-side network apparatus.

In one embodiment, the present invention may also include client-side and server-side network connection setting method. The client-side network connection setting method of the present invention is capable of controlling a processor, such as a computer, to execute a network connecting operation mode requesting step to determine which of a plurality of network operation modes is preferred. The method also includes a setting information receiving step for receiving the setting information and a network connecting operation mode processing step for setting the predetermined network connecting operation mode using the setting information.

The server-side network connection setting method of the present invention includes controlling a processor, such as a computer, to receive a request for setting information of the network connecting operation mode, and to transmit the setting information in response to the information request.

According to one aspect of the present invention, exclusive packets are used for exchanging the setting information of operation modes. These packets may be introduced into a plurality of different network apparatus. Accordingly, the present invention is capable of allowing a network apparatus to be configured according to a network operation mode with substantially little intervention by a user.

### BRIEF DESCRIPTION OF THE DRAWINGS

Further features and advantages of the invention can be ascertained from the following detailed description that is provided in connection with the drawings described below:

FIG. 1 is a schematic diagram of an exemplary network system according to one embodiment of the present invention.

FIG. 2 is a block diagram of a router and a modem according to one embodiment of the present invention.

FIG. 3 is a processing flowchart of a router according to one embodiment of the present invention.

FIG. 4 is a processing flowchart of a modem according to one embodiment of the present invention.

FIGS. 5A-5B are packet diagrams of the PPPoE mode according to one embodiment of the present invention.

FIGS. 6A-6B are packet diagrams of the bridge mode according to one aspect of the present invention.

FIGS. 7A-7B are packet diagrams of the NAT mode when the DHCP is provided according to one embodiment of the present invention.

FIGS. 8A-8B are packet diagrams of the NAT mode when the DHCP is not provided according to one embodiment of the present invention.

### DETAILED DESCRIPTION OF THE PREFERRED EMBODIMENT

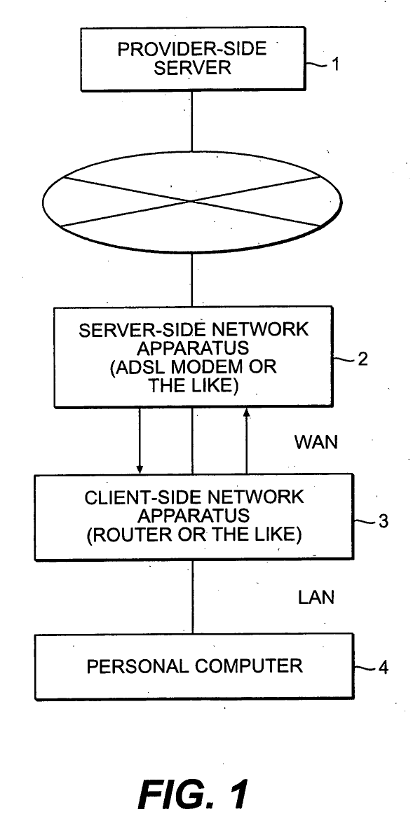

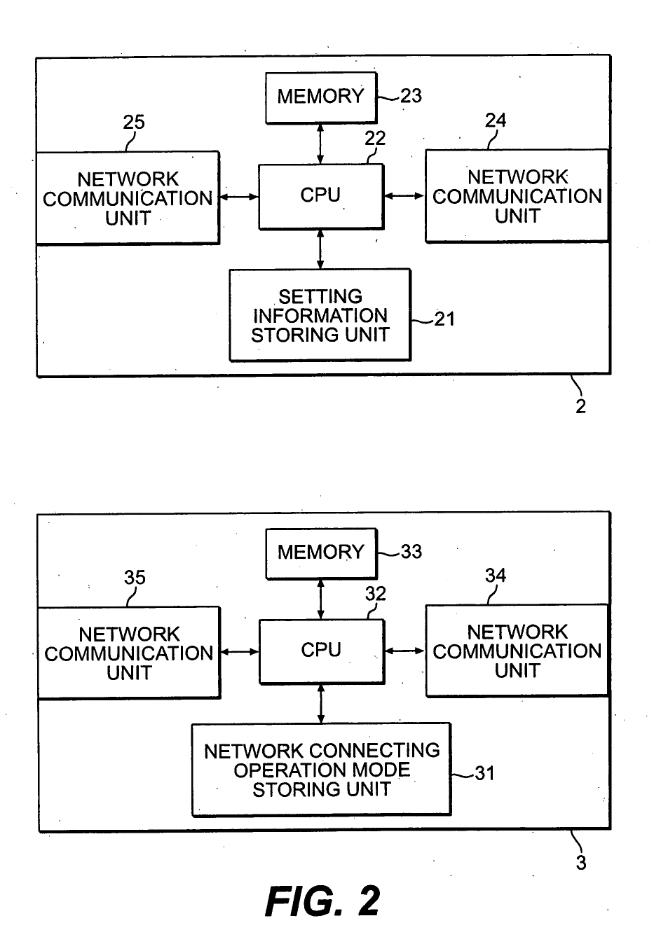

FIG. 1 is a diagram showing an overview of one embodiment of the present invention.

In FIG. 1, reference numeral 1 designates a server of provider; 2, a server-side network apparatus; 3, a client-side network apparatus; 4, a personal computer.

In one embodiment, the server-side network apparatus 2 may be, for example, an ADSL modem. The client-side network apparatus 3 may be, for example, a router. As described herein, reference numeral 2 designates an ADSL modem, while 3 designates a router.

In one embodiment, the server 1 and ADSL modem 2 are connected through, for example, a telephone link. The ADSL modem 2 may be connected through a LAN (Local Area Network) cable to the router 3, which may be connected to a personal computer 4 also through, for example, a LAN cable.

In this embodiment, the client-side network apparatus 3 may be connected to the ADSL modem 2 through a WAN (Wide Area Network) port and may also be connected to the personal computer through a LAN port.

The router 3 transmits, upon connection to the ADSL modem 2, a request packet through the broadcast. The ADSL modem 2 preferably returns the setting information, which may then be added to the router 3. Therefore, the router 3 may be capable of setting the desired operation mode based on the received setting information packet. This preferably eliminates the need for a user to perform troublesome procedures required to configure a network environment.

As described herein, Numeral 21 designates a setting information storage unit; 22, a central processing unit (CPU); 23, a memory; 24, 25, network communication units. Additionally, numeral 3 designates a router, 31, an operation mode storage unit; 32, a central processing unit (CPU); 33, a memory; 34, 35, network communication units.

In one embodiment, the ADSL modem 2 may be connected to the router 3 through the network communication unit 24. The modem 2 may also be connected to a server 1 of the provider through the network communication unit 25. It may be desirable for the ADSL modem 2 to previously determine using the CPU 22, the setting information of any of the operation modes of, for example, PPPoE mode, bridge mode, and NAT mode. After the predetermined operation mode is stored to the setting information storage unit 21 after setting to any of the PPPoE mode, bridge mode, and NAT mode, the ADSL modem 2 is maintained in the waiting condition.

Upon reception of the request packet from the router through the network communication unit 24, the CPU 22 determines whether the setting mode is PPPoE mode or not.

If the setting mode is not the PPPoE mode, the setting information packet may be transmitted through the network communication unit 24. When the setting mode is the PPPoE mode, whether the Address 1 as the IP address information in the request packet is identical to the network address of the ADSL modem or not is determined.

When the network address of Address 1 is identical to that of the ADSL modem, the other address to be set for the router 3 as the Address 2 is registered within the setting information packet and the setting information packet is transmitted through the network communication unit 24.

In one embodiment, the router 3 transmits, upon connection to the ADSL modem through the network communication unit 35, the request packet to the ADSL modem. Here, the network communication unit 34 is preferably-operatively connected to the personal computer 4.

The CPU 32 is capable of determining the number of times of transmission reaches a specified value or not. When such number of times of transmission has reached the specified value, the operation mode of the specified value is set and is then stored to the network connecting operation mode storing unit 31.

When the number of times of transmission does not reach the specified value, the CPU 32 determines whether the setting information packet has been received from the ADSL modem 2 or not. If the setting information packet is not yet received through the network communication unit 35, the request packet is transmitted. When the setting information packet is received, the state of the setting information packet is determined. As used herein, the state corresponds to setting mode. When the state is the PPPoE mode, the operation mode is set to the PPPoE mode, while the state is bridge mode, the operation mode is set to the bridge mode. When the state is the NAT mode, the CPU 3 determines existence or non-existence of DHCP in the setting information packet.

When the operation mode is set to the PPPoE mode and it is then stored to the network connecting operation mode storing unit 31, the router is driven again.

In one embodiment, when the operation mode is set to the bridge mode and it is then stored to the network connecting operation mode storing unit 31, the CPU 32 preferably determines whether the Address 2 is included in the setting information packet or not. When the Address 2 is not included, the router may be re-driven. In one embodiment where the Address 2 is included, the Address 2 may be set as the IP address.

In one embodiment where the operation mode is the NAT (Network Address Translation) mode, the DHCP client mode may be set, if the DHCP is included. The IP address in the side of the network communication unit 35 may be set with the DHCP. It may be desirable for the CPU 32 to determine whether the Address 1 is identical to the IP address in the side of the network communication unit 34 or not. If the Address 1 is substantially different from the IP address, the router may be driven again. When the Address 1 is identical to the IP address in the side of the network communication unit 34, the IP address in the network communication unit 34 is changed to the other address and the router is re-driven. If the DHCP is not included, the operation mode is set to the manual setting mode and the Address 2 is set to the IP address in the network communication unit 35. Whether the Address 1 is identical to the IP address in the network communication unit 35 or not is preferably determined. If the Address 1 is different from the IP address, the router may preferably be driven again. If the Address 1 is identical to the IP address, the IP address in the network communication unit 34 may be changed to the other address and the router may be re-driven.

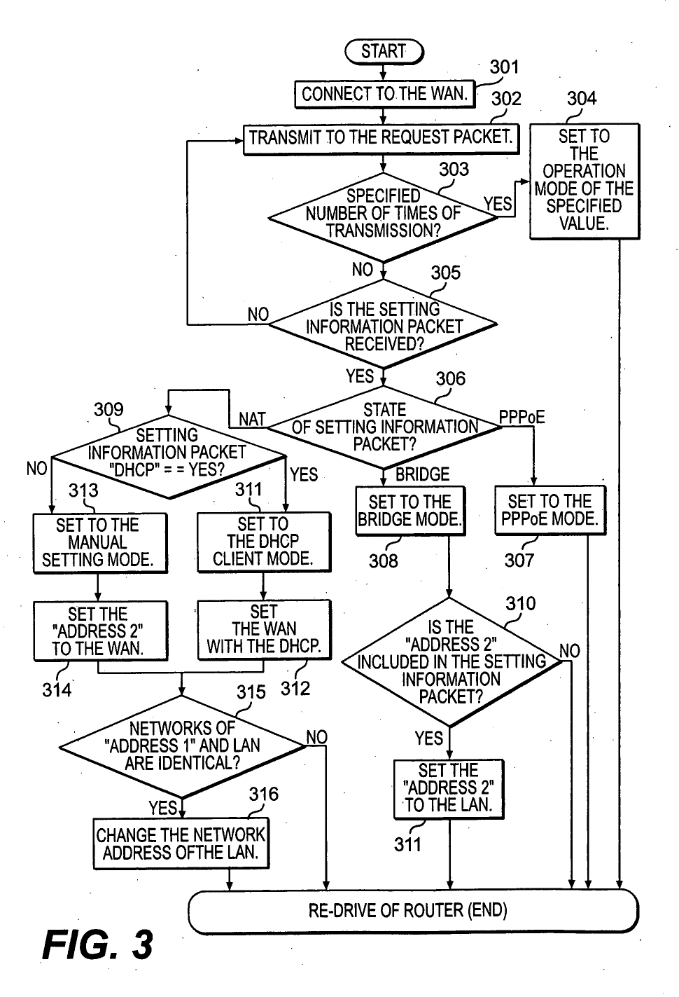

FIG. 3 is a diagram showing a setting process flowchart of the router according to one embodiment of the present invention. In one embodiment, the router may be operatively connected to the modem based on the WAN (step 301). Preferably, the request packet is transmitted to the modem (step 302). Whether the number of times of transmission has reached the specified value or not may then be determined (step 303).

In one embodiment, when the number of times of transmission has reached the specified value, the operation mode is set to correspond to the specified value. If the number of times of transmission does not reach the specified value, whether the setting information packet has been received from the modem or not is determined (steps 304, 305).

If the setting information packet has not been received, a request packet may be transmitted. When the setting information packet is received, the state of the setting information packet may be determined (steps 302, 306). When the state is the PPPoE mode, the operation mode may be set to the PPPoE mode, while the state is the bridge mode, the operation mode may be set to the bridge mode. When the state is the NAT mode, existence or non-existence of the DHCP within the setting information packet may determined (steps 307, 308, 309).

When the operation mode is set to the PPPoE mode, the router is re-driven. If the operation mode is set to the bridge mode, whether the Address 2 is included in the setting information packet or not may be determined. When the Address 2 is not included, the router is driven again, and when the Address 2 is included, the Address 2 may be set to the LAN (steps 310, 311).

In embodiments where the operation mode is set to the NAT, the DHCP client mode is set if the DHCP is included (step 311). The WAN may also be set with the DHCP (step 312). Whether the Address 1 is identical to the network address in the LAN or not may be determined. When the Address 1 is different from the network address of LAN, the router may be re-driven. When the Address 1 is identical to the network address of LAN, the network address of LAN may be changed to the other address and the router may be driven again (step 316). In one embodiment, when the DHCP is not included, the operation mode may be set to the manual setting mode and the Address 2 may be set to the WAN (steps 313, 314). Whether the Address 1 is identical to the network of LAN or not is preferably determined. When these are different, the router may be driven again. When these are identical, the network address of LAN may be changed to the other address and the router may be driven again (step 316).

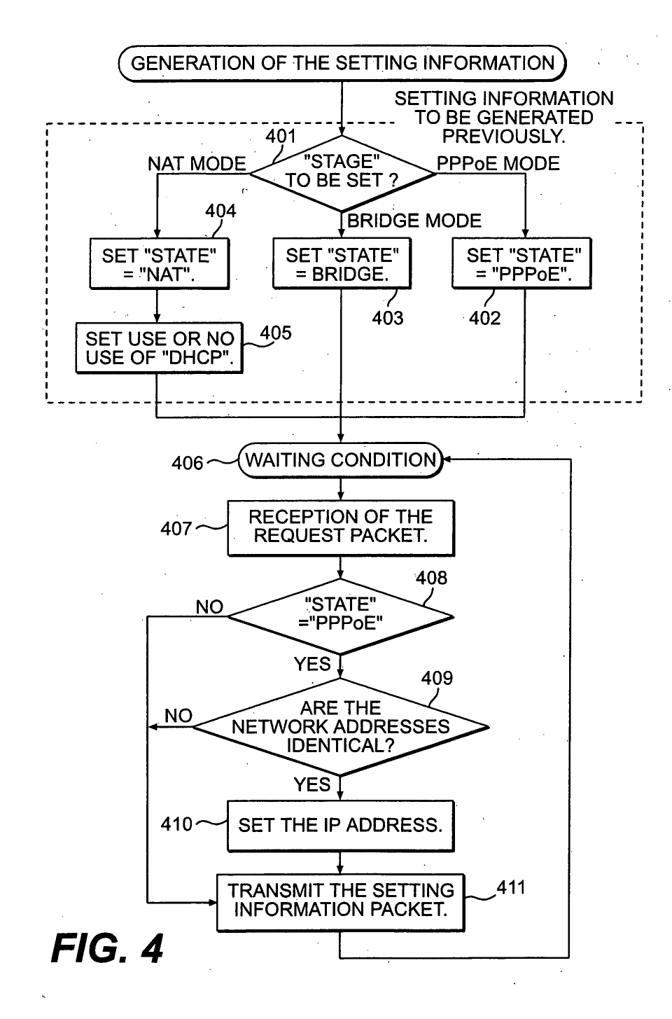

FIG. 4 is a diagram illustrating a flowchart of the ADSL modem according to one aspect of the present invention.

In one embodiment, it is desirable to determine whether any setting information of the PPPoE mode, bridge mode, and NAT mode should be generated (step 401).

In one embodiment, when the setting information is the PPPoE mode, the operation mode is preferably set to the PPPoE mode. If, however, the setting information is the bridge mode, the operation mode may be set to the bridge mode. Alternatively, when the setting information is the NAT mode, the operation mode may be set to the NAT mode. When the NAT mode is set, whether the DHCP may be used or not may be determined (steps 401, 402, 303, 404, 405).

When the operation mode is set to any of the PPPoE mode, bridge mode, and NAT mode, the ADSL mode enters the waiting condition (step 406). If the request packet is received from the router, whether the state is the PPPoE mode or not may be determined (step 407).

If, however, the state is not the PPPoE mode, the setting information packet may be transmitted. When the state is the PPPoE mode, whether the Address 1 of request packet is identical to the network address of the modem or not may be determined (steps 411, 409). When the Address 1 and network address of modem are identical, the other address may be set to the router and the setting information packet may be transmitted to the Address 2 (steps 410, 411).

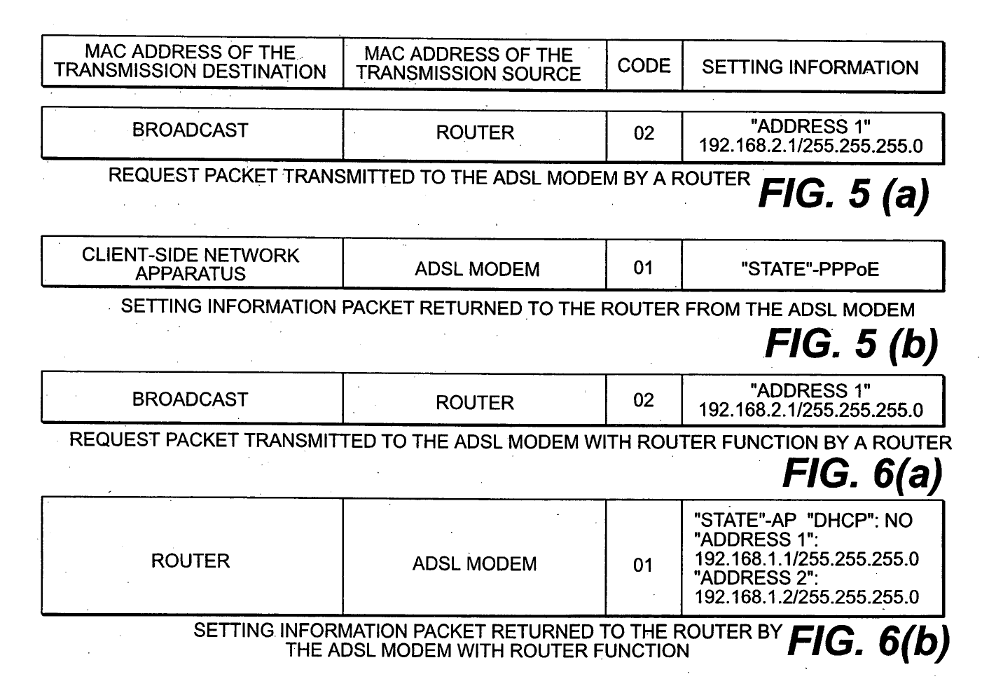

FIGS. 5A and 5B are exemplary packet diagrams for the request packet and setting information packet when the router is set to the PPPoE mode. FIG. 5A illustrates the request packet which may be transmitted to the modem by the router. FIG. 5B illustrates the setting information packet to be returned to the router by the modem. Here, the router is assumed to have the PPPoE function. Moreover, the modem comprises an ADSL modem.

In this embodiment, the router is operatively connected to the ADSL modem. The IP address of the ADSL modem in the WAN side is assumed, for example, as 102.168.1.1/255.255.255.0, 102.168.2.1/255.255.255.0, and the IP address of router in the LAN side as 192.168.2.1/255.255.255.0.

In one embodiment, the request packet of FIG. 5A is capable of sequentially indicating, from the left side, the transmission destination MAC address, transmission source MAC address, code, and setting information. The transmission destination and transmission source MAC address columns may be filled, from the viewpoint of the expression, with the device names of the transmission destination and transmission source. In one embodiment, 01 and 02 may be used as the codes. The code 01 preferably indicates the setting information packet, while the code 02 preferably indicates the request packet.

In one embodiment, the router transmits, after connection to the ADSL modem, the request packet, with broadcast. The modem then returns the setting information packet to which the necessary setting information is added to the router. The router may then set the PPPoE mode with the setting information of the setting information packet and drives again the router. Since the address information may not be included in the setting information, the IP address in the LAN side of router is 192.168.2.1/255.255.255.0.

FIGS. 6A and 6B are packet diagrams illustrating the exemplary request packet and exemplary setting information packet when the router is set to the bridge mode. In this embodiment, the modem comprises the ADSL modem with the router function. Preferably, the router transmits, after connection to the ADSL modem with the router function, the request packet with the broadcast. The ADSL modem with the router function may then return, to the router, the setting information packet to which the setting information written in the “Address I” of the request packet is added.

In an embodiment where the router is set to the bridge mode with the setting information of the setting information packet, the LAN and WAN become the identical network and the router may be driven again. In one embodiment, the IP address of router, the “Address 2” may be set as the IP address using the “Address 1” of the setting information packet as the default gateway.

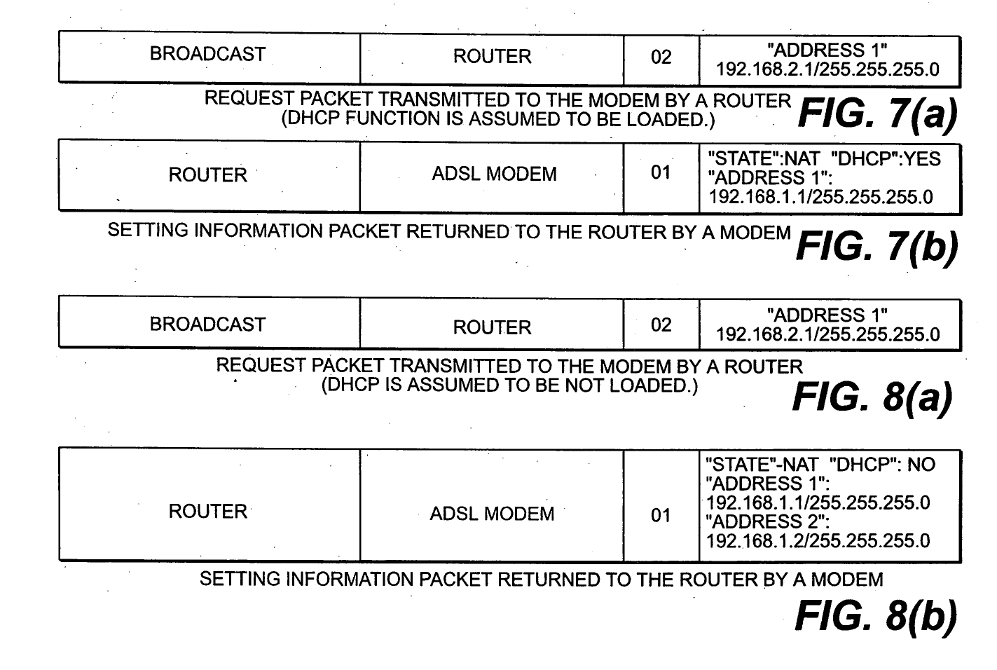

FIGS. 7A and 7B are packet diagrams of the exemplary request packet and exemplary setting information packet in the NAT mode. FIG. 7A illustrates the request packet, while FIG. 7B, illustrates the setting information packet. In one embodiment, the router is operatively connected to the LAN environment. In this embodiment, it is assumed that the DHCP (Dynamic Host Configuration Protocol) function is loaded to the router. The DHCP is a method of dynamically assigning the IP address to the computer on the LAN. When the computer logs in the network, the DHCP assigns one of the prepared IP addresses to this computer. In this embodiment, it is assumed that the IP address in the side of LAN 2 of the modem is 192.168.1.1/255.255.255.0, while the IP address in the side of LAN 3 of the router is 192.168.1.1/255.255.255.0.

In one embodiment, the router transmits, after connection to the modem, the request packet with the broadcast. The modem may then return, to the router, the setting information packet to which the necessary setting information is added. The router preferably sets up the DHCP client mode on the basis of the setting information packet.

The IP address in the side of LAN 2 may be obtained with the DHCP. In one embodiment, the IP address in the side of LAN 3 of router is preferably set to the network which is different from that of the IP address written in the “Address 1” of the setting information packet. For example, the IP address, 192.168.1.1/255.255.255.0 may be changed to 192.168.2.1/255.255.255.0. Thereafter, the router may be driven again.

FIGS. 8A and 8B are packet diagram illustrating the exemplary request packet and exemplary setting information packet when the MAT mode is set. In one embodiment, the router is operatively connected to the LAN environment. Here, it is assumed that the DHCP function is not loaded to the router.

The router preferably transmits, upon connection to the modem, the request packet with the broadcast. The modem then returns, to the router, the IP address of the distant party determined on the basis of the IP address of the router written in the “Address I” of the request packet and the setting information packet to which the other necessary setting information may be added.

In one embodiment, the router sets the manual setting mode based on the setting information included in the setting information packet. In regard to the IP address in the side of LAN 2 of the router, the “Address 2” may be set as the IP address using the “Address 1” of the setting information packet as the default gateway. In one embodiment, the IP address in the side of LAN 3 of the router is set to the network in a different manner than that of the IP address written in the “Address 1” of the setting information packet. For example, the IP address 192.168.1.1/255.255.255.0 may be changed to 192.168.2.1/255.255.255.0. It may be desirable for the router to be driven again.

Next, examples of modification of the embodiment of the network apparatus of the present invention described above and the other technical extension items will be discussed.

In the embodiment discussed above, the ADSL modem is assumed to be the server-side network apparatus, while the router is assumed to be the client-side network apparatus. However, the present invention is not limited thereto and other network apparatus conforming to such apparatuses may also be used.

In the embodiments discussed above, the server-side network apparatus, the client-side network apparatus, and the personal computer are connected to the network through the network communication unit. However, in other embodiments these may also be connected through, for example, the LAN cable or wireless LAN system.

In the embodiments discussed above, the apparatus which is used by the users is not limited only to a personal computer. Any processor known to those skilled in the art may be used.

In the embodiments discussed above, setting of the operation mode is not limited to the transmitting/receiving apparatus. Other transmitting/receiving apparatus based on the packets and the operation mode may be used according to a particular application.

In the embodiments discussed above, the PPPoE mode, bridge mode, and NAT mode may be set as the operation modes of the router. However, the present invention is not limited thereto and other operations modes known to those skilled in the art may also be selected.

In one embodiment, the present invention may comprise a computer program product that performs one or more of the functions described above. As used hereto, a computer program product may include, but is not limited to, computer code, computer disks, code stored in a memory, devices capable of implementing computer code, a computer readable medium, computer program instructions recorded on a computer readable medium executable by a processor, and the like.

Although the present invention has been described with reference to particular embodiments, it will be understood to those skilled in the art that the invention is capable of a variety of alternative embodiments within the spirit of the appended claims.

1. A client-side network apparatus which may be connected to a network and is capable of selecting a network connecting operation mode, comprising:
a network connecting operation mode storing unit which stores a plurality of network connecting operation modes;
a network communication unit which transmits request information for requesting a network connecting operation mode to be configured according to network apparatus connected to the network and receives setting information including a determined network connecting operation mode from the plurality of network connecting operation mode from the network apparatus; and
a network connecting operation mode processing unit which configures the determined network connecting operation mode based on the setting information.

2. The client-side network apparatus according to claim 1, wherein the client-side network apparatus comprises a router.

3. The client-side network apparatus according to claim 1, wherein the network connecting operation modes to be stored in said network connection mode storing unit include at least one of the PPPoE mode, bridge mode, and NAT mode.

4. A server-side network apparatus which is capable of connecting at least two portions of a network, comprising:
a setting information storing unit which stores the network connecting operation mode which network apparatus connected to the network configures; and
a network communication unit which receives request information for requesting the setting information from said network apparatus and transmits the setting information to said network apparatus.

5. The network apparatus according to claim 4, wherein said server-side network apparatus comprises an ADSL modem.

6. A client-side network connection setting program for setting a network connection among two or more network apparatus, wherein a processor executes:
a network connecting operation mode requesting step which determines the network connecting operation mode to be set.
a setting information receiving step which receives the setting information including a determined network connecting operation mode request; and
a network connecting operation mode processing step which set the determined network connecting operation mode from said setting information.

7. The client-side network connection selling program according to claim 6, wherein the network connecting operation mode requesting step comprises choosing one operation mode from a plurality of network connecting operation modes stored within the network apparatus.

8. A server-side network connection setting program for setting a network connection among two or more network apparatus, wherein a processor executes:
a request information receiving step which receives the setting information including the network connecting operation mode from network apparatus connected to the network; and
a network connecting operation mode setting information transmitting step which transmits the setting information based on the request information.

9. A method for configuring a network connection among two or more network apparatus, comprising:
storing a plurality of network connection operation modes in a first apparatus;
transmitting request information to request a network connection operation mode of a network;
receiving setting information including a determined network connection operation mode from a second network apparatus; and
configuring the first network apparatus according to the network connection operation mode of the network.

10. The method according to claim 9, wherein the first network apparatus comprises a router.

11. The method according to claim 9, wherein the network connection operation modes comprise at least one of PPPoE mode, bridge mode, and NAT mode.

12. The method according to claim 9, wherein the second network apparatus comprises an ADSL modem.

13. The method according to claim 9, wherein the transmitting and receiving are based on packets.

14. The method according to claim 9, wherein the configuring is based on one of the stored network connecting operation modes.

15. A computer program product for configuring a network connection among two or more network apparatus, comprising:
storing a plurality of network connection operation modes in a first apparatus;
transmitting request information to request a network connection operation mode of a network;
receiving setting information including a determined network connection operation mode from a second network apparatus; and
configuring the first network apparatus according to the network connection operation mode of the network.

16. The computer program product according to claim 15, wherein the first network apparatus comprises a router.

17. The computer program product according to claim 15, wherein the network connection operation modes comprise at least one of PPPoE mode, bridge mode, and NAT mode.

18. The computer program product according to claim 15, wherein the second network apparatus comprises an ADSL modem.

19. The computer program product according to claim 15, wherein the transmitting and receiving are based on packets.

20. The computer program product according to claim 15, wherein the configuring is based on one of the stored network connecting operation modes.
